(19) United States
(12) Patent Application Publication
(10) Pub. No.: US 2012/0117185 A1
(43) Pub. Date: May 10, 2012

(54) DIRECT NAVIGATION TO A REMOTE MEDIA ARCHIVE ON A MOBILE COMMUNICATIONS DEVICE

(75) Inventor: Brendon P. Cassidy, Los Angeles, CA (US)

(73) Assignee: CRICKET COMMUNICATIONS, INC.

(21) Appl. No.: 13/158,333

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/425,192, filed on Dec. 20, 2010.
(60) Provisional application No. 61/430,079, filed on Jan. 5, 2011.

(51) Int. Cl. G06F 15/16

(52) U.S. Cl. 709/217

(57) ABSTRACT

The techniques introduced here provide for efficient navigation between a media listing on a mobile communications device and a remote archive of downloadable content related to the media listing. The techniques include for example, navigating to an album that a song in the media listing comes from and displaying content available on a media service for download from that album. Further, the content available for download can be distinguished from content already stored locally on the mobile communications device. The techniques also include navigating to an artist associated with a song or album in the media listing and displaying content available for download by that artist. The mobile communications device can store an indication of the original media listing such that a user can automatically be returned to the original media listing.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, to Provisional Patent Application No. 61/394,222 entitled “Media Server Providing Unlimited Media Access Over Wireless Infrastructure” filed Oct. 18, 2010, and to Provisional Patent Application No. 61/430,079 entitled “Direct Navigation To A Remote Media Archive On A Mobile Communications Device” filed Jan. 5, 2011, the contents of all four of which are incorporated herein by reference.

### FIELD OF THE INVENTION

The present disclosure relates to providing unlimited access to media, such as music and ring tones, to a mobile handset over wireless infrastructure, and more particularly to managing the unlimited access to media, local storage of accessed media, and local playback of media from the mobile handset.

### BACKGROUND

Mobile communications devices have been adapted to a wide variety of applications, including computing, communication, and entertainment. For example, mobile communications devices permit users to freely initiate and receive voice communications, e.g. through dial-up connections or push-to-talk. Further, mobile communications devices have been developed to provide users with access to data communications through wireless connectivity, such as over Institute of Electrical and Electronic Engineers (IEEE) 802.11 or 3G/4G networks. Data communications can provide a user with access to a wide variety of entertainment options, including audio, video, and gaming content.

Services have been developed which permit a user to load media content, e.g. music and videos, onto a mobile communications device for subsequent playback. For instance, media content can be purchased from an on-line source, such as in accordance with a pay-per-song model. Purchased media content can be downloaded to a computing device, such a desktop or a laptop. Further, the content can be transferred off-line to from the computing device to a mobile communications device, e.g. through a sync (or synchronization) procedure. The media content can then be played back on the mobile communications device using a playback application. Once the media content is no longer desired on the mobile communications device, it can be deleted. If the media content is deleted, either purposefully or inadvertently, or if the mobile device is lost, the media content must be repurchased if it is once again desired. Accordingly, media device functionality, e.g. an MP3 player, can be incorporated into a mobile communications device.

Internet radio (or web radio or streaming radio) also has been developed to stream music over a network, such as the internet, to receivers that can play the streamed content. Internet radio typically is implemented similar to traditional broadcast radio in that the streamed content cannot be paused or replayed. Further, channels can be programmed to feature a particular style, type, or genre of content, but cannot be programmed by the listener. Additionally, the streamed content is not persistently stored on the receiver, so play back is possible only when a connection to the streaming source is available.

### SUMMARY

A mobile communications device (or “handset”) can be configured to operate in conjunction with a service structured to provide a subscriber with unlimited access to and/or unlimited use of media content. Unlimited access and/or unlimited use can be truly unlimited, such that no restrictions are placed on the amount of media that can be downloaded in a given period, e.g. a week or a month. Alternatively, unlimited access and/or unlimited use can be structured to impose one or more restrictions, such as a limitation on network traffic, e.g. measured in megabytes or gigabytes, over a given period, e.g. an hour or a day. The media content can include one or more of audio content (e.g. music), video content (e.g. television, movies, shorts), text-based content (e.g., e-books), and any combination thereof. Additionally, media content structured for use in communications, e.g. ring tones and ring back tones, also can be accessed by the mobile communications device.

Unlimited access to media content also can be provided in conjunction with one or more communications services, including one or more of voice communications, text communications, and data communications. The mobile communications device can be adapted to provide access both to the media content and to the communications services. For instance, the mobile communications device can be associated with a subscription to a single, unlimited-use offering that includes access to media content and one or more communications services.

The present inventors recognized a need to provide a mobile communications device configured to provide access to a local media archive and a remote media archive. The need to permit using the mobile communications device to select media, such as one or more songs, for download from the remote media archive to the local media archive also was recognized. Further, the present inventors recognized the need to permit adding one or more items of media to a play queue or a play list for local playback on the mobile communications device. The need to augment or revise a play queue or play list, including during playback, also was recognized.

The present inventors also recognized the need to permit switching the interface presented by the mobile communications device directly from a view of a media item included in the local media archive to a corresponding view of the media item in the remote media archive. Further, the need to provide a secure, removable storage medium, e.g., a memory card, on which the local media archive can be stored also was recognized.

The techniques described in this specification can be implemented to realize one or more of the following advantages. The techniques can be implemented such that a mobile communications device can store locally an archive of media based on a subscription plan instead of a pay-per-download model. The techniques also can be implemented to permit authorizing a user to access media on the mobile communications device based on having an active subscription. Further, the techniques can be implemented to permit navigating from content in a local media archive to related content in a remote media archive in response to a user command. For instance, if a user is listening to a song on a particular album, a single user command can take the user to a listing of all songs from that album that are available for download from the remote media archive. Further, the listing of available songs can include an indication of which songs are already stored in the local media archive.

The details of one or more implementations are set forth in the accompanying drawings and the description below. Other features and advantages will be apparent from the description and drawings, and from the claims.

### BRIEF DESCRIPTION OF THE DRAWINGS

One or more embodiments of the present invention are illustrated by way of example and not limitation in the figures of the accompanying drawings, in which like references indicate similar elements.

FIG. 1 shows an exemplary computing environment in which media can be transferred to a mobile communications device.

FIG. 2 shows an exemplary mobile communications device.

FIG. 3 shows an exemplary data flow between a mobile communications device, a computing device, and a server.

FIG. 4 shows exemplary media interfaces associated with a media application that can be presented by a mobile communications device.

FIGS. 5A, 5B, 5C, 5D, 5E and 5F show exemplary interfaces associated with local and remote media archives that can be presented by a mobile communications device.

FIGS. 6A and B show exemplary media application interfaces for social interaction in the media application.

FIG. 7 is a flow diagram of an example process for navigating a remote media archive from a mobile communications device.

FIG. 8 illustrates an example of accessing related media content in a remote media archive based on an item of media content stored in a local media archive.

FIG. 9A shows exemplary media interfaces associated with a media application that can be presented by a mobile communications device.

FIGS. 9B, 9C, 9D, 9E, 9F, 9G, and 9H show additional exemplary navigational jump concepts in various context and applications between.

### DETAILED DESCRIPTION

The described techniques for direct navigation can be implemented across different hierarchical areas to allow the user to quickly and easily ‘Jump’ between things, areas, content items, etc. that are thematically or contextually linked with each other. The thematic or conceptual linking can include manual linking by a subscriber or dynamic linking performed by the described system. Dynamic linking can be performed based on past behaviors, preferences, etc. of the subscriber. Also, the dynamic linking can be performed based on categories, such as recommend tracks, new releases, top albums and/or songs, featured songs and/or albums, etc.

For example, the described direct navigation allows a subscriber to transition between a local music view, e.g., a playback interface, and a music store view directly, in a single action. Traversal through a menu structure is not required and the user can navigate by jumping within the context of the same application or across different applications.

A subscriber can discover additional content associated with an item of local media content directly from a local interface, e.g., a MyMusic interface or a GetSocial interface. For instance, from a local interface identifying an item of content, the subscriber can ‘jump’ to the music store to view additional items of associated content, such as all of the songs associated with an album.

The navigational jump can be performed contextually, such that the jump from a selected item, e.g., an artist, takes the subscriber to an interface in the music store that shows a corresponding level of content, e.g., all of the works—such as albums—associated with that artist.

The music store interface can be “aware” of the subscriber's locally stored content. For example, the subscriber's instance at the Cloud includes a list of the subscriber's local content. Accordingly, the music store interface can differentiate content items already locally stored by the subscriber from remaining content items, such as through one or more graphical elements. The subscriber can then select content for download that is not already locally stored. (Alternatively or additionally, all selected content can be evaluated against the subscriber's locally stored content to prevent the transfer of redundant content items.)

In operation, a subscriber can jump from a local interface in which a content representation has been selected (either expressly or inherently, i.e., a content item is selected by virtue of being the only item in a playback interface) to a music store interface. The music store interface can present related content, e.g. at a higher contextual level. For instance, if a track is selected in the local interface, the music store interface can show multiple tracks, such as in an album view. The subscriber further can select one or more items of displayed related content for downloading. Multiple items can be selected at any time, from any displayed interface. A selected content item also can be deselected to cancel downloading of that item.

Further, the subscriber can navigate away from the music store interface at any time. For instance, the subscriber can jump back to the local interface from which the jump was performed. The subscriber also can navigate to other interfaces within the music store.

These and other aspects of the described technology are described in various embodiments and examples. References in this specification to “an embodiment”, “one embodiment”, or the like, mean that the particular feature, structure or characteristic being described is included in at least one embodiment of the present disclosure. Occurrences of such phrases in this specification do not necessarily all refer to the same embodiment and do not limit the disclosed subject matter to a single embodiment.

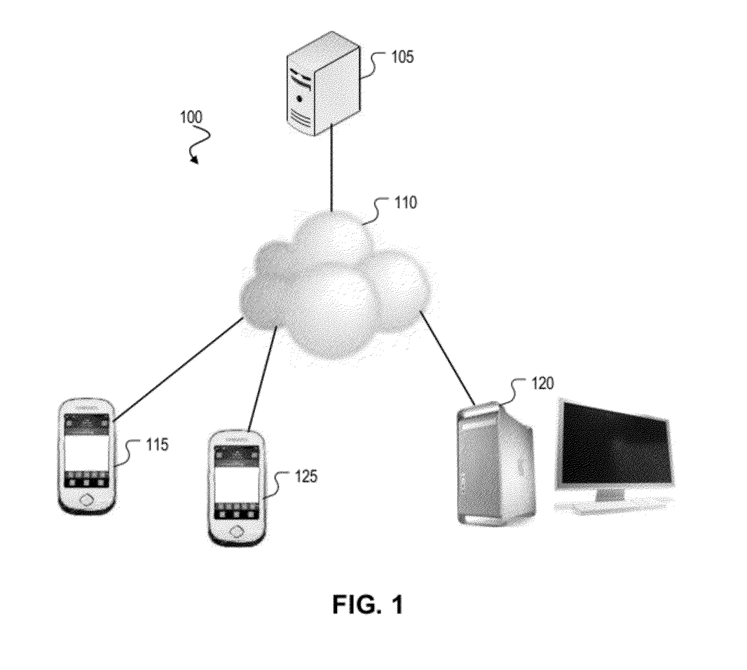

FIG. 1 shows an exemplary computing environment in which media can be transferred to a mobile communications device. Computing environment 100 can include a server 105 (or “the cloud”) configured to provide access to and management of media content. Server 105 can be implemented using a single computing device or multiple computing devices, which can be co-located or distributed across two or more locations. For instance, in some implementations, server 105 can be implemented using one or more application servers, web servers, and data servers, which can be housed in one or more locations.

Server 105 can host one or more applications configured to manage subscribing users. For instance, server 105 can be configured to validate a mobile communications device before the device is authorized to perform media related functions, including accessing locally stored media and downloading media from server 105. Further, server 105 can maintain an instance of one or more user accounts, including user account details, for example, mobile identification number and subscriber name, locally stored music, subscribed play lists, managed play lists, play back history, and contacts. Server 105 also can host a media catalog (or media archive), which can be accessed through a subscribing mobile communications device in order to select media for download to the mobile communications device. Additionally, server 105 can be configured to manage the transfer of music to one or more subscribing mobile communications devices, including the transfer of specifically requested media and the automated transfer of media based on a subscription, for example, to a play list.

Server 105 can be adapted to communicate with subscribing users over a network 110, which can be implemented using one or more data networks. For instance, network 110 can include either or both of wired and wireless communication links. Further, network 110 can be a public network, for example, the Internet, a private network, for example, a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g., roaming partners.

Mobile communications device 115, which is associated with a subscribing user, also can be configured to communicate over network 110, for example, with server 105 and with other mobile communications devices 125. In some implementations, the other mobile communications devices 125 need not be associated with other subscribing users. Any number of mobile communications devices 115 can be included in computing environment 100. As the number of mobile communications devices 115 increases, server 105 and network 110 can be scaled, e.g., by adding additional resources, to provide an acceptable level of service. A mobile communications device 115 can be any mobile device configured to communicate over the network 110 with a host service provider, e.g., server 105. For instance, a mobile communications device 115 can be a mobile telephone that is adapted to transmit and receive data communications, e.g., a smart phone, a personal digital assistant, a tablet computing device, a mini-computer, a micro-computer, a notebook computer, a laptop, or any other such computing device.

A mobile communications device 115 further can include a data storage device configured to receive and store media content. The data storage device can be adapted to provide secure storage for the media content, as well as to perform digital rights management functions, e.g., decrypting media content for playback on the mobile communications device 115. In some implementations, the data storage device can be a removable device, e.g., a flash memory module. Thus, a local media library can be stored across multiple data storage devices, which can be swapped to provide access to different portions of the library.

A mobile communications device 115 also can include a display, e.g., a liquid crystal display (LCD) or a light emitting diode (LED) display, and one or more user input devices, such as a touch screen (resistive or capacitive), a touch pad, one or more buttons, one or more keys, a scroll wheel, a dial, a switch, a microphone, or any other such input device. Further, a mobile communications device 115 can be adapted to communicate using one or more protocols, such as 3G, Wi-Fi, or other such protocols. For instance, a mobile communications device 115 can be configured to communicate over Wi-Fi when possible and otherwise to use a 3G connection.

Additionally, computing environment 100 can include one or more computing systems 120. A computing system 120 can be implemented using a computing device, such as a desktop computer, a laptop computer, a notebook computer, a net book, a tablet computing device, a workstation, and a server. Computing system 120 also can be configured to transmit and receive data over network 110, e.g., over a TCP/IP connection. Thus, computing system 120 can be adapted to provide data communications with server 105. For instance, computing system 120 can be used to perform functions relating to a subscribing user's account, such as account management and the selection of media.

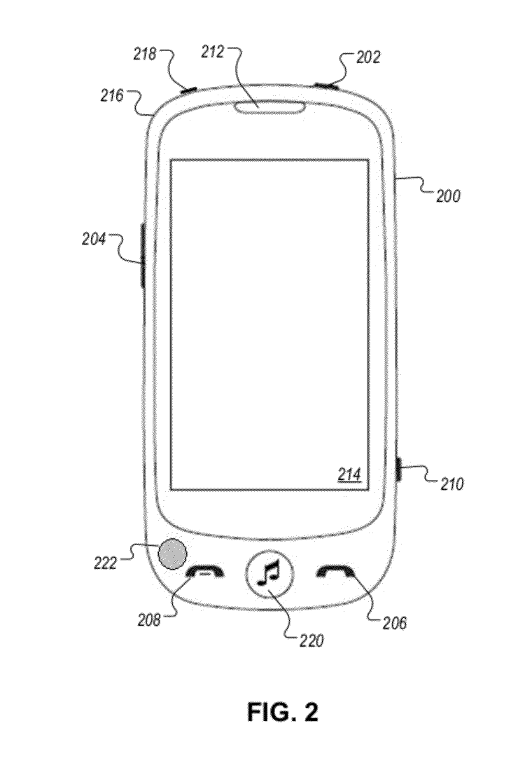

FIG. 2 shows an exemplary mobile communications device. Mobile communications device 200 can be configured to provide wireless voice communication and data communication. The device 200 can include physical controls, e.g., a power button 202, a volume control 204, a phone button 206, an end call button 208, and a camera button 210. Further, the device 200 can include outputs, such as speaker 212 and display 214, which can be a touch sensitive display, e.g., resistive or capacitive. Display 214 can be configured to sense either or both of simple gestures (e.g., touching, swiping, etc.) and complex gestures, such as multi-touch gestures. In some implementations, the device 200 also can include one or more additional speakers 216 to provide for additional audio output. The one or more speakers can be located on any or all of the peripheral edges, the back, and the front of the device 200. One or more of the included speakers, e.g., the one or more speakers 216, can be used to implement audio playback and/or speakerphone functionality. An accessory jack 218, e.g., for headphones, also can be included. Further, the device 200 can have an integrated digital signal processor (DSP) that can provide for customized tuning of audio output. For example, the DSP can be adapted to provide a graphic equalizer, e.g., a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g., off, low, medium, and high, which can correspond to software configured bundles of parameters for the compressor's various level, ratio, attack, and decay parameters for each band. Also, one or more frequencies that cannot be reproduced by a given output device, e.g., the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g., a home menu, to be presented. The device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause the music player interface to be displayed, while pressing and holding can cause a home screen of a remote media catalog (or store) to be displayed. The device 200 also can include physical controls for other functions, including volume and traversing back in the interface.

Also, in some implementations, a back button 222 can be included on the device 200. For implementations in which a back button 222 is included, the corresponding functionality can be removed from one or more interfaces presented on the device 200. For instance, one or more interfaces, e.g., associated with a media application, can include a virtual (or “soft”) command button or other such icon that can be selected to navigate backward within the interface hierarchy, such as to a preceding interface screen. When the back button 222 is included as a physical control on the device 200, it can be selected to perform the navigation function associated with the virtual command button, e.g., returning to a preceding interface screen, and the virtual command button can be removed to simplify the interface. In some other implementations, physical and virtual command buttons can be provided for one or more functions, including navigation.

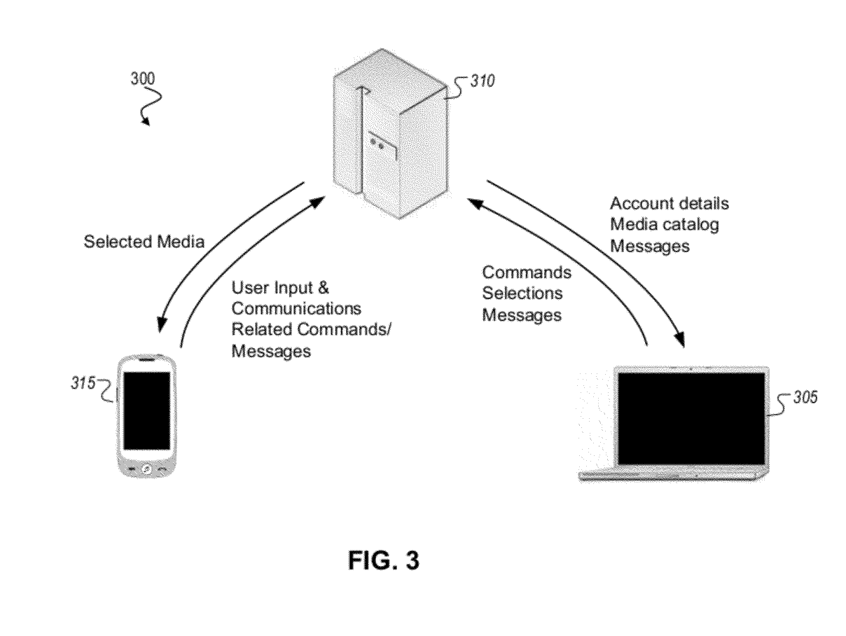

FIG. 3 shows an exemplary data flow between a mobile communications device, a computing device, and a server. Computing environment 300 can include a computing device 305, a server 310, and a mobile communications device 315 or to computing device 305. Computing device 305 can be implemented using any computer, including a desktop computer, a laptop computer, a net book, a tablet computer, a workstation, and a server. Further, server 310 can be implemented using one or more servers, e.g., as a combination of servers forming a virtual server, including one or more application servers, data servers, and web servers. Additionally, mobile communications device 315 can be any communication device configured to provide data communications, e.g., a smart phone or web-enabled phone.

Server 310 can communicate separately with both computing device 305 and mobile communications device 315. For instance, server 310 can communicate with computing device 305 over a public network, e.g., the internet, a private network, e.g., a local area network (LAN), or a combination thereof. Further, server 310 can communicate with mobile communications device 315 over a network that includes a wireless data network link, e.g., to a 3G or 4G network. Further, computing device 305 can communicate with mobile communications device 315 via a communications network, e.g., via a Wi-Fi or a 3G or 4G network. In some implementations, computing device 305 and mobile communications device 315 can be configured such that they do not communicate directly with each other.

Computing device 305 can communicate with server 310 to perform operations relating to one or more hosted media applications. For instance, computing device 305 can perform account management functions, messaging, and play list management. Server 310 can provide one or more interfaces to computing device 305. In some implementations, the one or more interfaces can be formatted for a larger display and thus can include additional information. Additionally, the one or more interfaces can be presented without installing an application or plug-in, e.g., as web pages presented in a browser. The interfaces can be compatible with multiple browsers, such that subscriber management from the computing device 305 can be platform independent.

The interfaces provided by server 310 can enable access to account details relating to a subscribing user, e.g., address and subscription information. Further, server 310 can provide access to at least a portion of a media collection, including one or more play lists. Items of media content can be selected from the media collection for download. Also, play lists can be managed, including generating play lists, modifying play lists, deleting play lists, subscribing to play lists and unsubscribing from play lists. Additionally, server 310 can provide access to messaging associated with a media application, including the ability to read messages that have been received and to generate new messages.

Server 310 further can be configured to transfer media content selected through computing device 305 directly to mobile communications device 315. For instance, a user can browse the media collection provided by server 310 through an interface provided by computing device 305, and can select one or more items of media content, e.g., songs, for download. The items of media content selected for download can be transferred, e.g., through an over-the-air download, directly to mobile communications device 315. As a result, mobile communications device 315 need not be synchronized with, or otherwise communicate with, computing device 305. Also, media content need not be downloaded to or stored on computing device 305. Thus, shared computing devices, e.g., library or school computers, can be used to perform account management and media management functions.

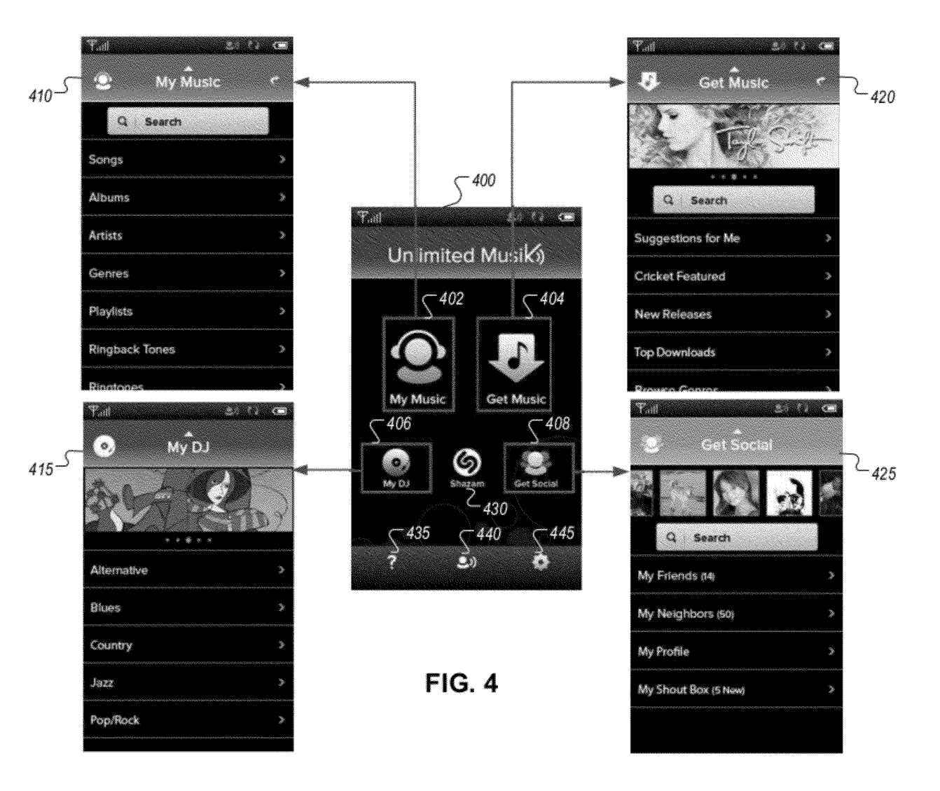

FIG. 4 shows exemplary media interfaces associated with a media application that can be presented by a mobile communications device. A home media interface 400 can be presented, which can provide access to functional areas within the media application as well as access to one or more utilities. The home media interface 400 can be the top-level interface for the media application. Home media interface 400 can include selectable icons corresponding to functional areas, including MyMusic icon 402, GetMusic icon 404, MyDJ icon 406, and GetSocial icon 408. An icon can be selected (or actuated) through any known technique, including through touch and cursor designation. The icons presented are representative and other implementations can include fewer, more, and/or different icons.

MyMusic icon (or button) 402 can be selected to present a local media interface 410, which can provide access to and browsing of the local media archive stored on the mobile communications device. The local media interface 410 can include categories by which the locally stored media can be sorted, including songs, albums, artists, genres, playlists, ringtones, and ringback tones. One or more other categories also can be included, such as music videos, television shows, and movies. Selecting a category from the local media interface 410 can present another interface, hierarchically organized as a sub-interface that shows media corresponding to that category, allowing a user to traverse the local media archive. The local media interface 410 also can include a search tool, which can be used to search the local media archive, e.g., using keyword searching.

GetMusic icon 404 can be selected to present a remote media interface 420, corresponding to a remote music archive or media store. The remote media interface 420 can provide access to and browsing of the remote media archive and can be configured to include categories by which the media is organized. For instance, the remote media interface 420 can include one or more categories corresponding to the local media interface 410, such as songs, albums, artists, genres, playlists, ringtones, and ringback tones. The remote media interface 420 also can include one or more other categories, including personalized suggestions, featured media, new releases, and top downloads, e.g., for a predetermined period of time, such as a day, week, or month. Selecting a category from the remote media interface 420 can present another interface, hierarchically organized as a sub-interface, that shows media corresponding to the selected category, allowing a using to traverse the remote media archive. The remote media interface 420 also can include a search tool, which can be used to search the remote media archive, e.g., using keyword searching.

MyDJ icon 406 can be selected to present a playlist interface 415, which can provide access to and browsing of the playlists available to the mobile communications device. The playlists can include either or both of local playlists, e.g., generated by the user of the device, and remote playlists that are generated by an external provider, such as another user or the system operator. The playlist interface 415 can include categories by which the playlists can be sorted, such as genre, content, and playlist source. For instance, the playlists can be organized using genres such as alternative, blues, country, jazz, and pop/rock. Selecting a category from the playlist interface 415 can present another interface, hierarchically organized as a sub-interface, that shows playlists corresponding to that category. In some implementations, the playlists shown can include playlists that are presently available, e.g., local playlists and subscribed playlists, and playlists that are not presently available but can be subscribed to. Further, the playlists that are presently available can be visually distinguished from those that are not, such as through highlighting or through the association of a graphical identifier.

GetSocial icon 408 can be selected to present a social interface 425, which can provide access to the subscriber's community. The community can include connected friends who also are subscribers to the media service, identified neighbors, and a Shout box that provides access to messaging within the media application and service. Further, the social interface 425 can provide access to the subscriber's profile, which can be used to describe and publicize subscriber characteristics, including musical preferences and the subscriber's local media archive. The social interface 425 also can include a search tool, which can be used to search the subscriber's social connections, e.g., using keyword searching.

Additionally, home media interface 400 can present one or more utility icons, which can be accessed to perform operations corresponding to the media application. For instance, a music recognition icon 430 can be selected to capture audio and submit it to a music recognition service. Also, a help icon 435 can be selected to access help, e.g., instructions or demonstrations, relating to one or more features and functions of the media application. A help interface organized by topics, such as functions, can be presented in response to selection of the help icon 435. In some implementations, a full tutorial for the media application also can be accessed.

A Shout icon 440 can be selected to access a Shout interface presenting the subscriber's Shout message box. The Shout message box can include Shout messages to and between all members of the subscriber's community. Further, the Shout interface can include an option to view only Shouts addressed to the subscriber and/or sent by the subscriber. Additionally, the home media interface 400 can include a settings icon 445, which can be selected to view and alter one or more media application settings, including synchronization status settings, social settings, card settings, and parental controls.

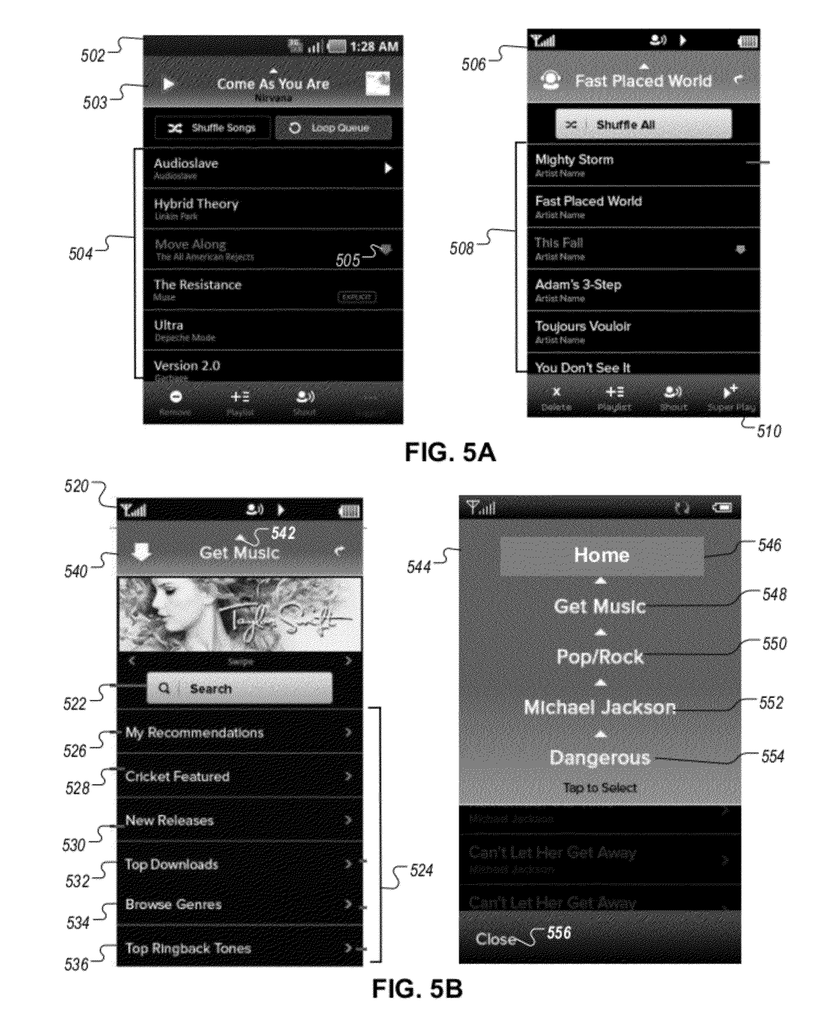

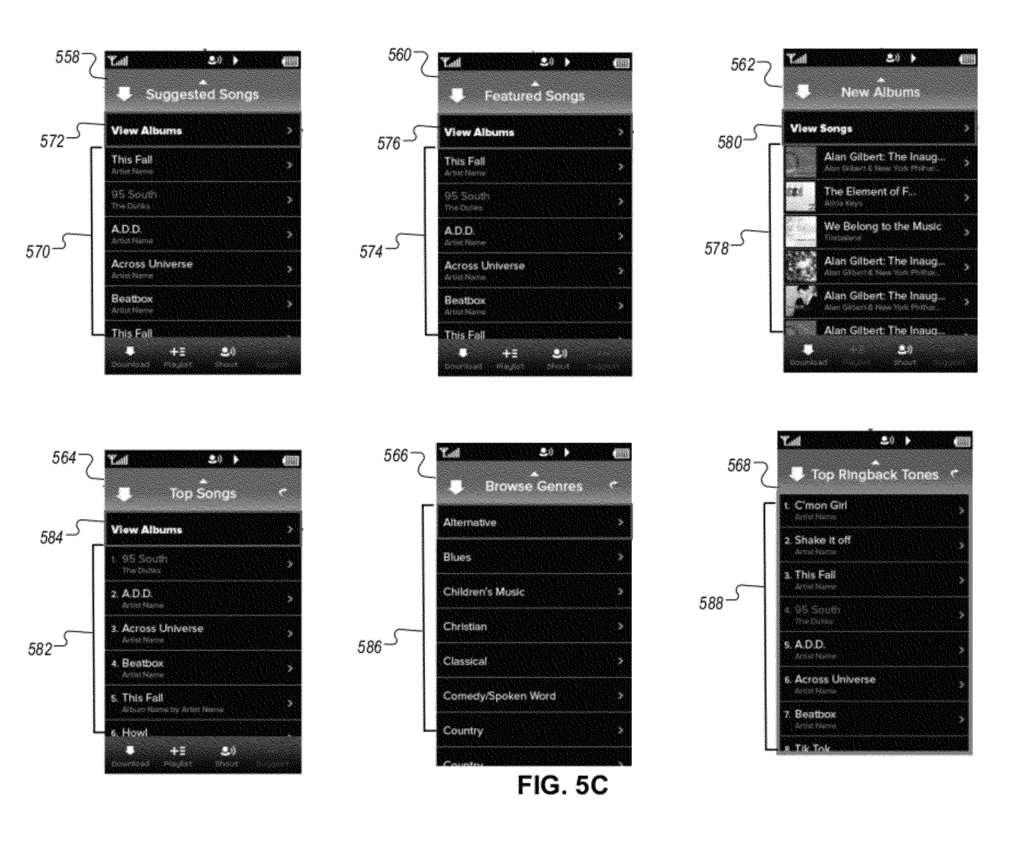

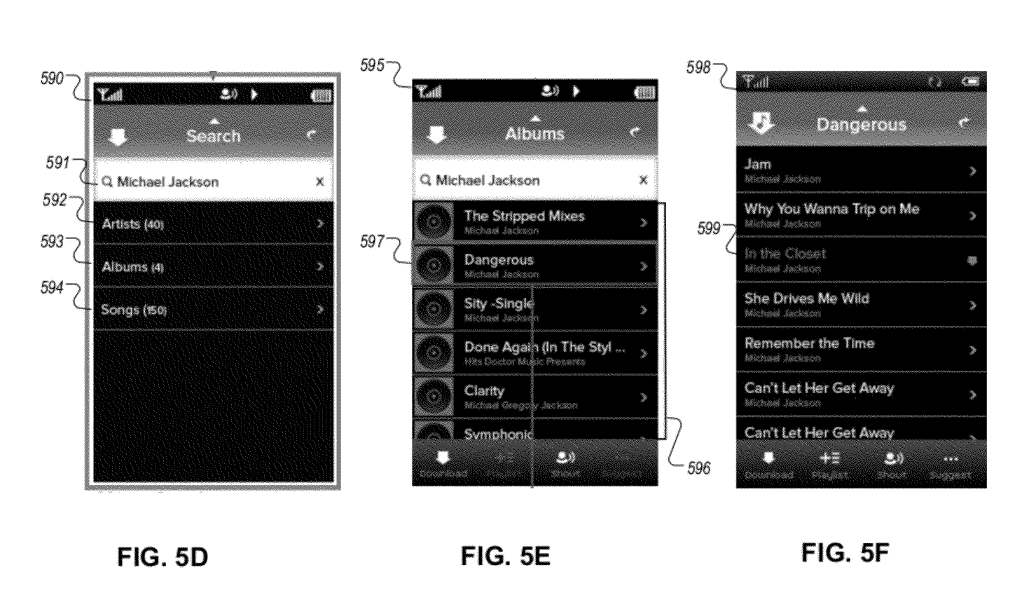

FIG. 5A shows exemplary interfaces associated with play queue management that can be presented by a mobile communications device. The media application can maintain a play queue for media playback by the mobile communications device. At any time, the play queue can include zero or more items of media, e.g. songs. Further, the media application's play queue can be managed from one or more of the functional areas of the media application, such as, for example, MyMusic, GetMusic, MyDJ, and GetSocial functional areas. Play queue management, for example, can be accessed at any time by selecting a play queue (or “SuperPlay”) icon or command button presented in an interface.

For instance, a play queue management interface 502 corresponding to a play queue for which one or more tracks are stored in the local media archive can be presented. The play queue interface 502 can include a currently-playing display area 503 for displaying the currently playing media content item (e.g., a song). In the example shown in FIG. 5A, the song ‘Come As You Are’ by Nirvana is currently playing. The play queue can also include a media (e.g., track) listing 504 identifying all of the tracks included on the play queue or only the tracks included in the local media archive. Either on the display area 503 or on the media listing, the play queue interface 502 can identify the name of the album, display the associated album cover, list the artist name, etc. in addition to displaying the title or name of each media content item. The track listing 504 can be scrollable and/or resizable if the number of tracks exceeds the amount of available display space in the interface. If the names of all tracks are displayed, the names of tracks that are stored in the local music archive, e.g., in MyMusic, can be visually distinguished from the names of the remaining tracks, such as through highlighting, text color, shading, or the presentation of a graphical device. Further, a download indicator 505 can be presented in association with a track in the track listing 504 that is in the process of being downloaded.

To manage the play queue from one or more of the functional areas of the media application, such as, for example, MyMusic, GetMusic, MyDJ, and GetSocial functional areas, the user can simply select one or more of the media content items from these functional areas by using the SuperPlay feature, for example. FIG. 5A also shows an exemplary MyMusic interface 506 that displays a list 508 of the available media content items in the MyMusic functional area. The MyMusic interface 506 can feature one or more user selectable command buttons, e.g., at the bottom of the interface, including a SuperPlay button 510 to allow a user to add media content items to the play queue.

FIG. 5B shows a GetMusic interface 520 corresponding to the GetMusic functional area of the media application. GetMusic interface 520 can include a user selectable command button 522 for searching within the GetMusic functional area to search for a particular media content item, album, etc. for example (see FIG. 5D for an exemplary search interface). In addition, the GetMusic interface 520 can include a user selectable list 524 of media content categories within the GetMusic functional area. The list 524 of media content categories can include My Recommendation 526, Featured 528, New Releases 530, Top Downloads 532, Browse Genres 534, Top Ringback Tones 536, etc. The list 524 of the media content categories allows the user to quickly access media content items organized based on a common theme, such as the New Releases 530. User actuation of a category from the list 524 displays a corresponding media content category interface (see FIG. C below) that displays a list of media content items (e.g., tracks) associated with the category, one or more of which can be selected for downloading.

The GetMusic interface 520 can also includes a title bar 540, e.g. presenting title information corresponding to the functional area (GetMusic in this example) the user is currently accessing. The title bar can include a navigation prompt 542, which can be selected to cause a navigation interface 544 to be presented. The navigation interface 542 can present a representation of the hierarchical navigation tree within the media application, e.g. between the top level of the application and the present level (or node). For instance, the navigation interface 544 can indicate that beneath the top level of the application, e.g. Home 546, the GetMusic 548 functional area of the application has been accessed. Further, the navigation interface 544 can indicate that the Pop/Rock 550 genre of the GetMusic 548 functional area has been accessed. Additionally, the navigation interface 544 can indicate that the artist level of the Pop/Rock 550 genre corresponds to Michael Jackson 552 and the album level beneath Michael Jackson 552 corresponds to the album Dangerous 554.

Navigation interface 544 also can be adapted to permit navigation to any other level in the hierarchy. For instance, the top level interface of the media application can be accessed by selecting the entry Home 546. Similarly, the Pop/Rock 550 genre level can be accessed by selecting that entry and an interface showing all of the artists associated with that genre can be displayed. Accordingly, any number of intervening levels of the navigation hierarchy can be skipped by selecting an entry from the navigation interface 544. Additionally, the navigation interface 544 can be closed and the previous interface, e.g. the get album interface, can be displayed in response to selection of the close button 556.

FIG. 5C shows exemplary interfaces 558, 560, 562, 564, 566 and 568 for My Recommendation 526, Featured 528, New Releases 530, Top Downloads 532, Browse Genres 534, and Top Ringback Tones 536 categories. Each of the interfaces 558, 560, 562, 564, 566 and 568 can include a list of media content items (e.g., tracks), albums, genres, etc. For example, the suggested songs interface 558 includes a list of suggested songs 570 for user selection and a user selectable command element (e.g., a button) 572 to select and/or view albums associated with songs in the suggested songs interface 558. The featured songs interface 560 includes a list of featured songs 574 for user selection and a user selectable command element 576 to select and/or view albums associated with songs in the featured songs interface 560. The new album interface 562 includes a list of new albums 578 for user selection and a user selectable command element 580 for selecting/viewing songs associated with the new albums 578. The top songs interface 564 includes a list of top songs 582 for user selection and a user selectable command element 584 to select and/or view albums associated with songs in the top songs interface 564. The browse genre interface 566 includes a list of genres 586 for user selection. The top ringback tones interface 568 can include a list of ringback tones 588 for user selection.

FIG. 5D shows a search interface 590 for selecting a media content item within GetMusic functional area. The search interface 590 includes a search query indicator 591, that displays the query topic or term used in the search. In the example, shown in FIG. 5D, the user has searched for Michael Jackson. The search interface 590 can also include search categories, such as Artists 592, Albums 593 and Songs 594 for user selection. User selection of Artist 592 allows the user to search by artist name. User selection of Albums 593 allows the user to search by album title. User selection of Songs 594 allows the user to search by song title.

FIG. 5E shows an Albums interface 595 for searching my album titles. Responsive to use selection of Albums 592 in the search interface 590, displays the album interface 595 that displays a list of available albums 596 for the user selection. In the example shown in FIG. 5E, the album Dangerous 597 by Michael Jackson has been selected. Responsive to user selection of the album Dangerous 597, a get album interface is displayed for user selection of songs within the album Dangerous.

FIG. 5F shows a get album interface 598 within the GetMusic functional area of the media application. Get album interface 598 can include a list of tracks associated with the album, one or more of which can be selected for downloading. For instance, track 599 can be visually distinguished, e.g. by color and a graphical indicator, to show that it is presently being downloaded to the subscriber's local media archive. Further, tracks that already are stored in the subscriber's local media archive can be visibly distinguished from the remaining tracks to indicate that they do not need to be downloaded.

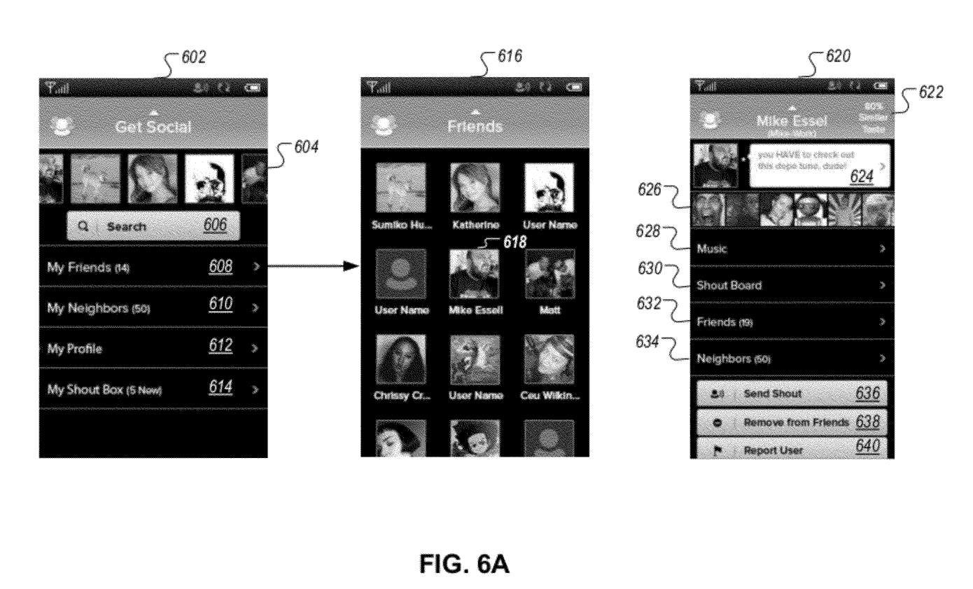

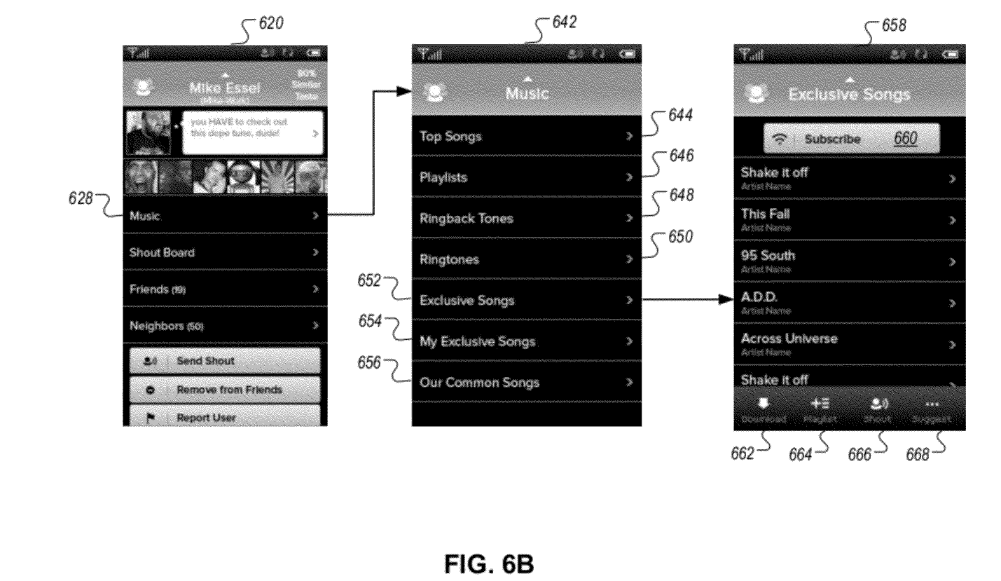

FIGS. 6A and B show exemplary media application interfaces for social interaction in the media application. Social interaction in the media application can be organized through the GetSocial functional area, although aspects of social interaction also can be implemented in one or more other functional areas. A GetSocial interface 602 can be presented as the top level interface for social functionality. The GetSocial interface 602 can include features and commands relating to interactions with other subscribers, including subscribers expressly designated as friends and subscribers designated by the media service as neighbors. For instance, the media service can designate one or more other subscribers as neighbors based on one or more factors, such as one or more of geographical proximity, common friends, and media preferences. In some implementations, one or more of the factors evaluated to determine whether two subscribers should be identified as neighbors can be weighted, e.g. in accordance with the factor's respect importance. For instance, two subscribers having nearly identical musical tastes can be identifies as neighbors even though they are geographically distant. Further, one or more factors can serve as thresholds. For instance, a particular geographical proximity, e.g. less than 500 miles, can be required to designate two subscribers as neighbors.

The GetSocial interface 602 can include a banner 604 showing images representing some or all of the subscriber's friends and/or neighbors. In some implementations, banner 604 can be scrollable, e.g. in response to touch input. Additionally, in some implementations, the media application can communicate with one or more contacts databases maintained on the mobile communications device, e.g. through an API, to identify contacts who can be added as friends if they also are subscribers, to add contact entries corresponding to individuals identified as friends, or both.

GetSocial interface 602 also can include a search button 606, which can be used to access a search tool. The search tool can be used to search, e.g. through one or more keywords, for individuals, e.g. friends, neighbors, or contacts. A listing of friends and neighbors also can be accessed directly. For instance, MyFriends button 608 can be actuated to show all of the individuals the subscriber has designated as friends, e.g. in friends interface 616. Also, MyNeighbors button 610 can be actuated to show all of the individuals who have been designated, e.g. by the media service, as neighbors of the subscriber. Further, MyProfile button 612 can be actuated to present a profile interface, through which aspects of the subscriber's profile can be accessed, such as the subscriber's music, shout message board, friends, and neighbors. Additionally, a MyShoutBox button 614 can be included to provide direct access to messages (shouts) received through the media service. In some implementations, the MyShoutBox button 614 can be presented only when new messages are in the message box.

Friends interface 616 can include images representing others the subscriber has designated as friends. The images can be photos, avatars, or other representative images. Also, a text identifier, e.g. a user name or screen name, can be associated with the image and can be persistently displayed or presented based on interface input, such as the positioning of a cursor. Further, an image can be selected through interface input to access an interface of the corresponding friend. For instance, selecting friend image 618 representing Mike Essel can cause the profile interface 620 for that friend to be presented.

The profile interface 620 can include a match identifier 622, indicating the degree of commonality between the subscriber's local media archive and the friend's local media archive. Also, the most recent public message posted by the friend can be presented in a Shout bubble 624. A scrollable banner 626 showing friends and/or neighbors of the accessed friend also can be presented, along with buttons to access public areas of the friends profile, including music 628, Shout board 630, friends 632, and neighbors 634. Additionally, one or more command buttons can be included in profile interface 620 to permit interaction with or about the friend, including SendShout button 636 to send a message to the friend, RemoveFromFriends button 638 to remove the friend from the subscriber's list of friends, and ReportUser button 640 to report the friend to the media service.

FIG. 6B shows an exemplary music interface 642, which can be presented in response to actuating the music button 628. The music interface 642 can present multiple categories of the friend's local music archive, which can be explored. For instance, the music interface 642 can include options to access the friend's top songs 644, playlists 646, ringback tones 648, and ringtones 650. Further, the music interface 642 can include one or more options for comparing the subscriber's local media archive with that of the friend. For instance, the Exclusive Songs category 652 can be accessed to present an Exclusive Songs interface 658 showing a listing of songs that are included in the friend's local media archive but not in the subscriber's local media archive. In contrast, the category My Exclusive Songs 654 can be accessed to show a listing of songs that are exclusive to the subscriber's local media archive, e.g. which can be recommended through a Shout message. Additionally, the category Our Common Songs 656 can be accessed to show a listing of songs appearing in the local media archive of both the subscriber and the friend.

The Exclusive Songs interface 658 also can include features and commands to permit the subscriber to perform operations relating to the list of songs. For instance, a subscribe button 660 can be actuated to subscribe to the friend's exclusive tracks. Also, one or more tracks can be selected from the listing and operated on using the download button 662, the playlist button 664, the shout button 666, and the suggest button 668. With the exception of downloading and subscribing, similar operations can be performed in interfaces corresponding to the subscriber's exclusive tracks and common tracks.

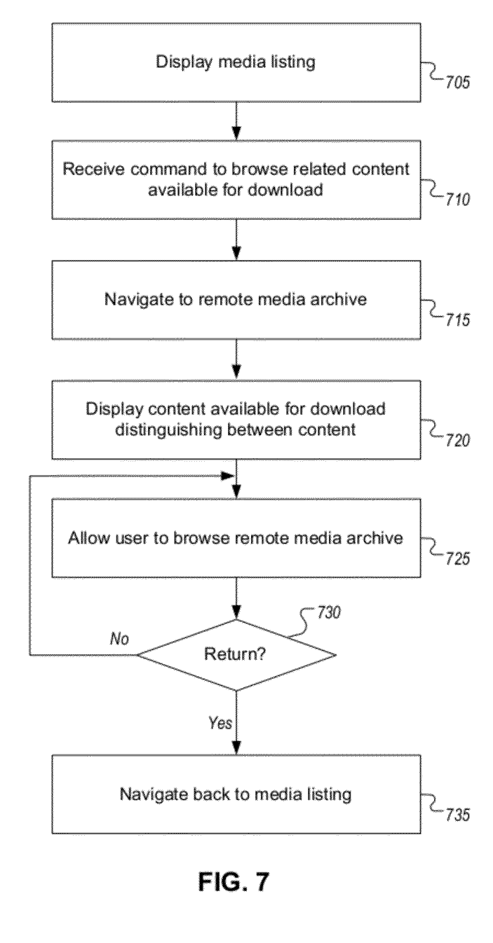

FIG. 7 shows an example process for navigating a remote media archive from a mobile communications device. A media listing can be displayed (705) to a user of the mobile communications device. The media listing can be, for example, a playlist of media stored on a local memory of the device, as depicted in FIG. 5, or a friend's playlist as depicted in FIG. 6B. Each of the items in the media listing is associated with one or more artists, playlists, albums, etc. The media listing can include a button that directs the user to a remote media archive (or music catalog) to browse downloadable content related to an item in the media listing.

When the mobile communication device receives a command to browse related content available for download (710), for example, when the user activates a button, the mobile communication device navigates to a remote media archive (715). Upon transfer, the user is directed to a location in the remote media archive that includes content for download that is related to the previously presented media listing. For example, a user can select a song in an album interface for which the user is interested in discovering other, related songs. When the user selects the song and activates the button to navigate to the remote media archive, the user is directed to a corresponding album listing of the remote media archive. In some implementations, the album listing of the remote media archive can show all of the songs associated with that album that are available on the service. In some other implementations, the album listing of the remote media archive can show all of the songs associated with that album and graphically identified songs that are available on the service. Additionally, in any implementation, the album listing of the remote media archive can graphically indicate which songs already have been added to the user's local media archive.

In another example, the user can be directed from a selected music listing associated with a functional area, e.g. one of the My Music, MyDJ, or Get Social functional areas, to an artist listing of the remote media archive, e.g. the Get Music functional area. The artist listing of the remote media archive can be presented based on the artist associated with one or more items of music in the selected music listing, and can show content available on the service that is associated with that artist. The artist listing can include all of the artist's songs that are available in the remote media archive. Further, in some implementations, the artist listing also can include one or more albums associated with the artist for which at least one song is available on the service. For example, if the song “Something Good This Way Comes” is selected in a music interface associated with a friend's profile when the command to transfer to the remote archive (e.g., the music store) is received, the next interface displayed can be an artist interface in the Get Music functional area that corresponds to Jakob Dylan. The artist interface can include each song associated with Jakob Dylan that is available on the service. For example, the artist interface can include songs recorded as a solo artist and songs by The Wallflowers. In some implementations, the artist interface also can include one or more albums, e.g. Seeing Things, that can be selected to view associated tracks.

The content available for download can be displayed in a manner such that the content that is already stored locally on the mobile communications device is distinguished from the content that is available for download (720). For example, the content that is stored locally on the mobile communications device can be grayed out, displayed in a different font, color, or otherwise distinguished. The server can maintain a record of the media locally stored on the communications device associated with an account and can reference that record in determining how to present content listings. The user can browse through the remote media archive (725) starting from the point of the album or artist related to the content stored locally on the mobile communications device. Further, the user can select one or more items of content for downloading to their local archive. For instance, items of content selected for downloading can be added to a listing or scheduler, such as a download queue or subscriber instance. Additionally, the user is free to navigate away from the initial artist or album to explore and/or download additional content available on the remote archive. The additional content may or may not be related to the initial album or artist.

When the user is ready to return to the original media listing (730), the mobile communication device allows the user to navigate back (735). For example, the user can activate a button to return directly to the original media listing from which the user accessed the remote media archive. In this instance, the mobile communications device maintains a record of the original media listing and upon detecting that the user has activated the button, navigates the user directly back to the original media listing. If the mobile communications device does not maintain a record of the original media listing, the user can navigate back to the original media listing using hierarchical navigation, e.g. as depicted in FIG. 5B.

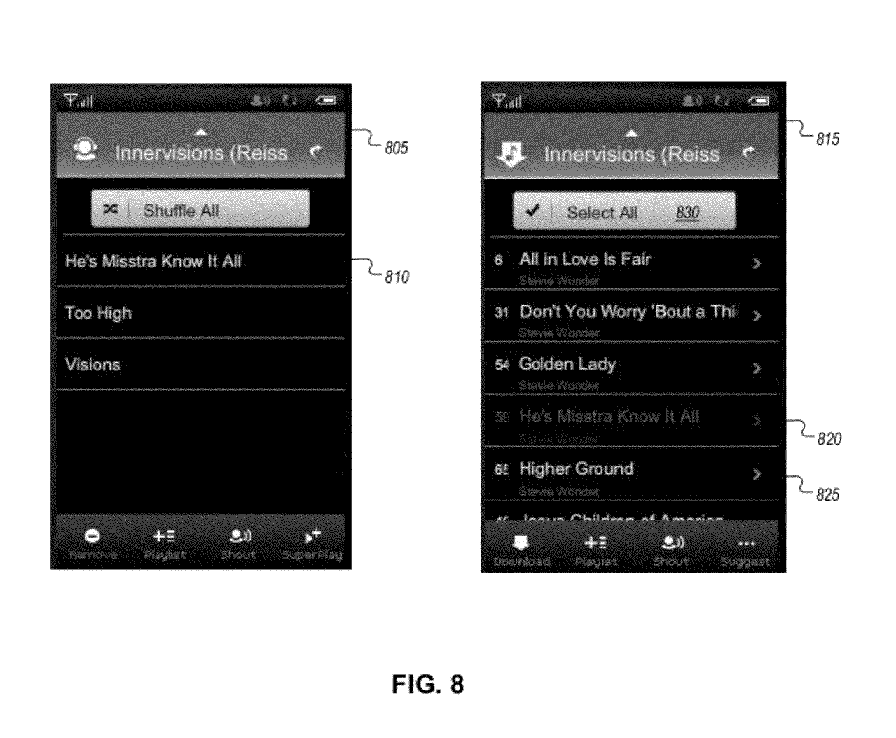

FIG. 8 illustrates an example of accessing related media content corresponding to a remote media archive based on an item of media content stored in a local media archive. A playlist interface 805, e.g., associated with the album Innervisions, can be presented by a media application at a mobile communications device. The playlist interface 805 can show all of the locally stored media items associated with a particular category, e.g., an album, artist, playlist, etc. Further, a command can be entered to cause a corresponding view of a remote media archive, e.g., the media or music store, to be displayed. For instance, a button press representing a command to access the media store can be received. In other implementations, any other command can be used to display the corresponding interface, such as input to a touch interface or input to a soft (or virtual) command button or other physical control.

In response to the command, the corresponding interface representing the remote media archive can be presented. The transition from the playback interface 805 to the view of the remote media archive can be implemented as a direct jump, without requiring the traversal of the application hierarchy. For instance, album interface 815 representing the album Innervisions in the remote media archive (i.e., the GetMusic functional area) can be presented in response to the command. The album interface 815 can list each of the tracks included on the album Innervisions that are available for download. Further, the tracks from the album Innervisions that already have been downloaded to the subscriber's local media archive can be visibly distinguished from the tracks that have not been downloaded, e.g., through the use of one or more graphical characteristics. For instance, the track He's Misstra Know It All 820 can be presented using one font color, e.g., gray, to indicate that it already has been downloaded. The track listing He's Misstra Know It All 810 appears in the playback interface 805, indicating that it is local content. Alternatively, the track Higher Ground 825 can be presented in a different font color, e.g., white, to indicate that it has not been downloaded to the local media archive. Thus, the subscriber can determine visually whether any tracks from the album have not yet been downloaded and can select one or more of those tracks for downloading.

The album interface 815 also can include a select all button 830, which can be used to select all of the listed tracks. One or more tracks that already have been downloaded to the local media archive can be individually deselected. Alternatively or additionally, the music service application can determine that one or more of the tracks selected for download already are stored locally at the subscriber's device, e.g., based on the subscriber's instance maintained by the server. As a result, transfer of the selected content that already is locally available can be cancelled and only the selected content that is not locally available can be transferred.

In some implementations, the view of the remote media archive can represent a different hierarchical level, such as artist or genre, or can be a combined view, e.g., listing all tracks associated with the artist that are available for download. A subscriber also can navigate from the album interface 815 to a different level of the GetMusic hierarchy through any of the available navigation means, including by selecting a node on a displayed hierarchical navigation tree. Additionally, another command can be entered to jump directly back to the playback interface 805 from the album interface 815.

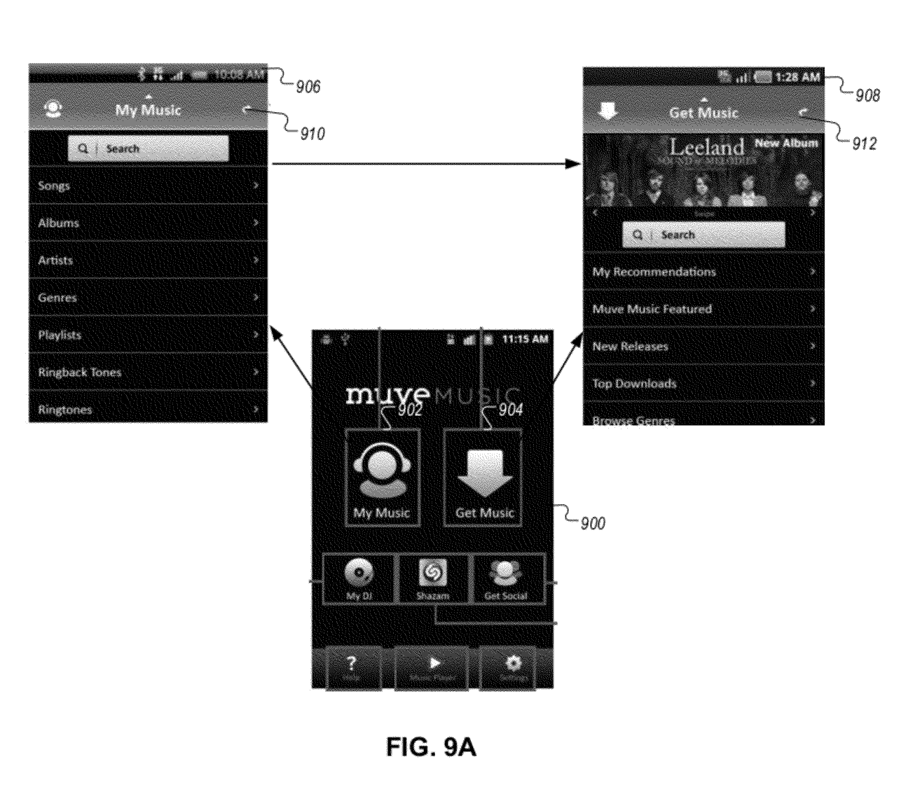

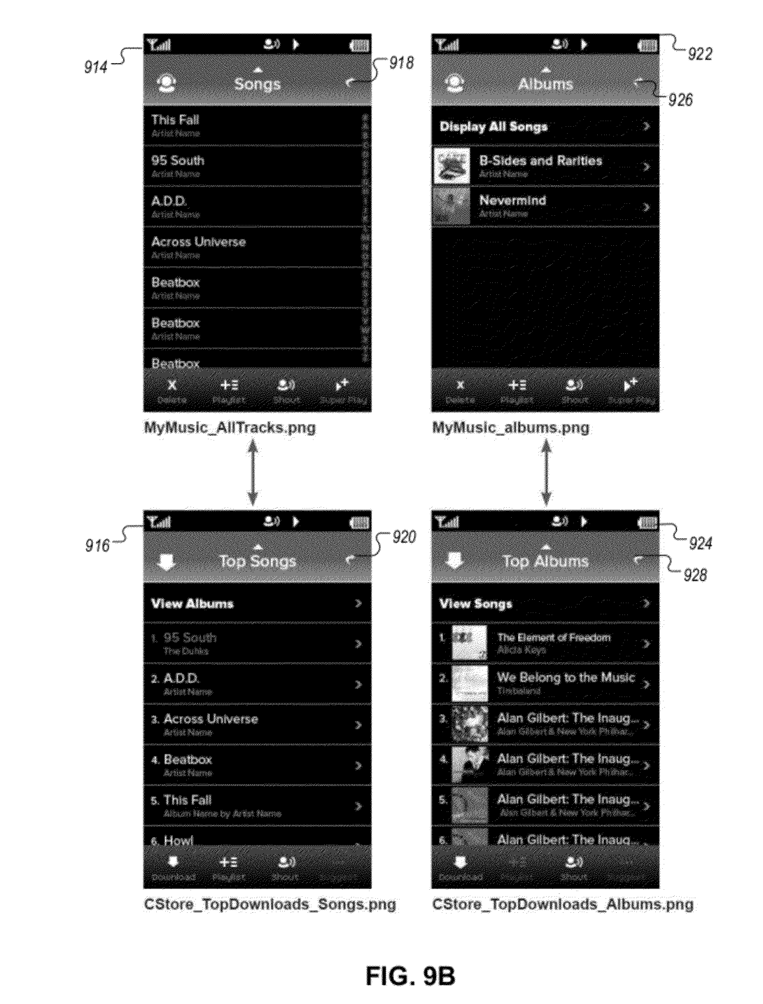

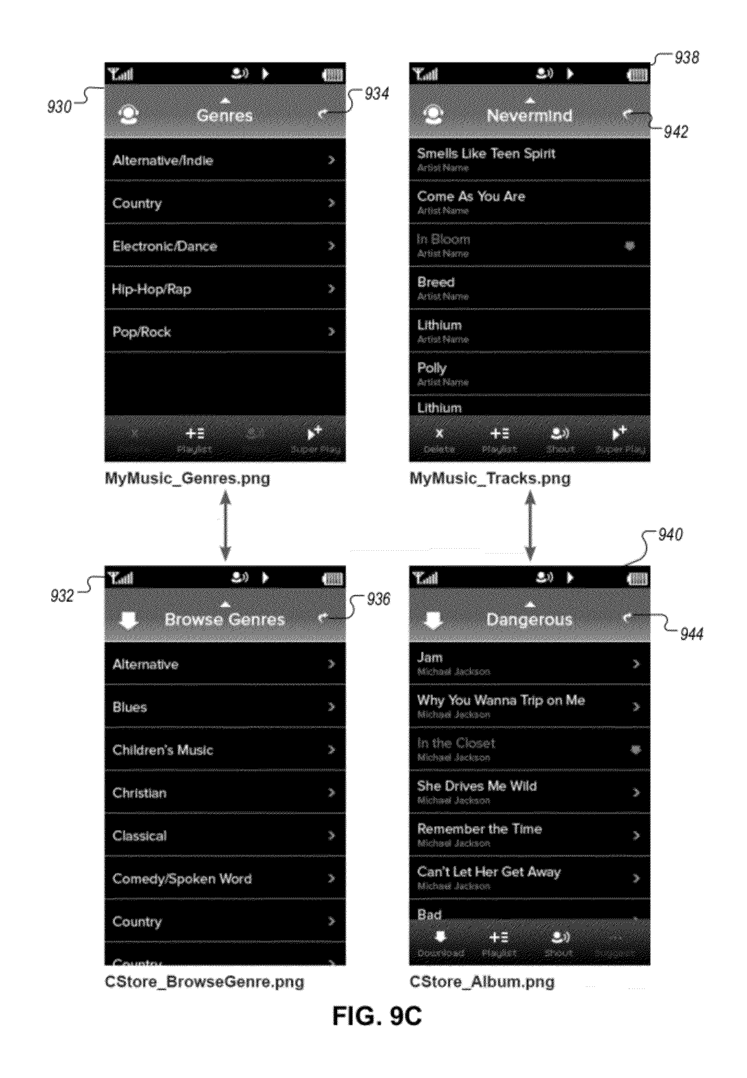

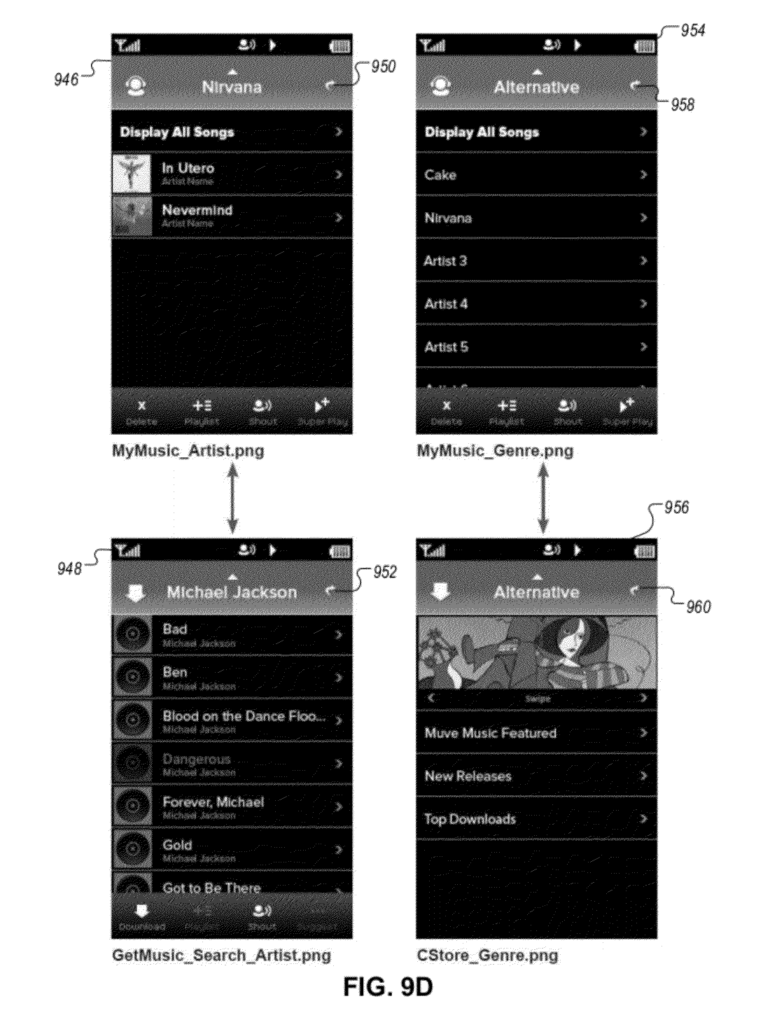

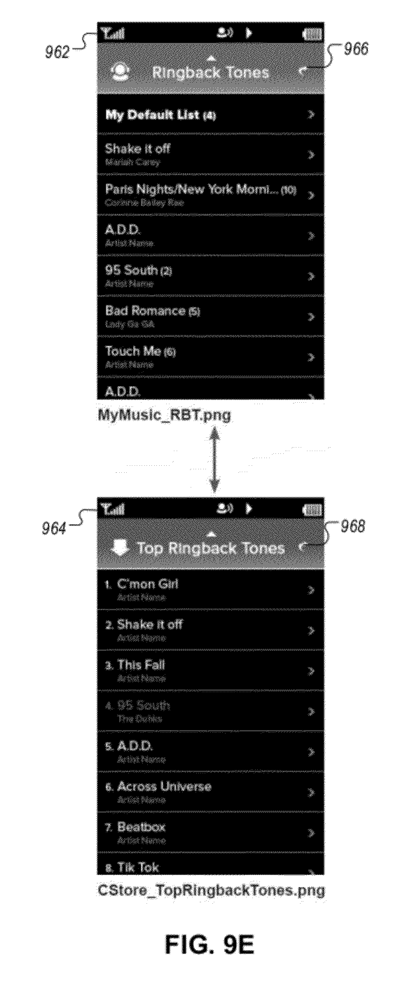

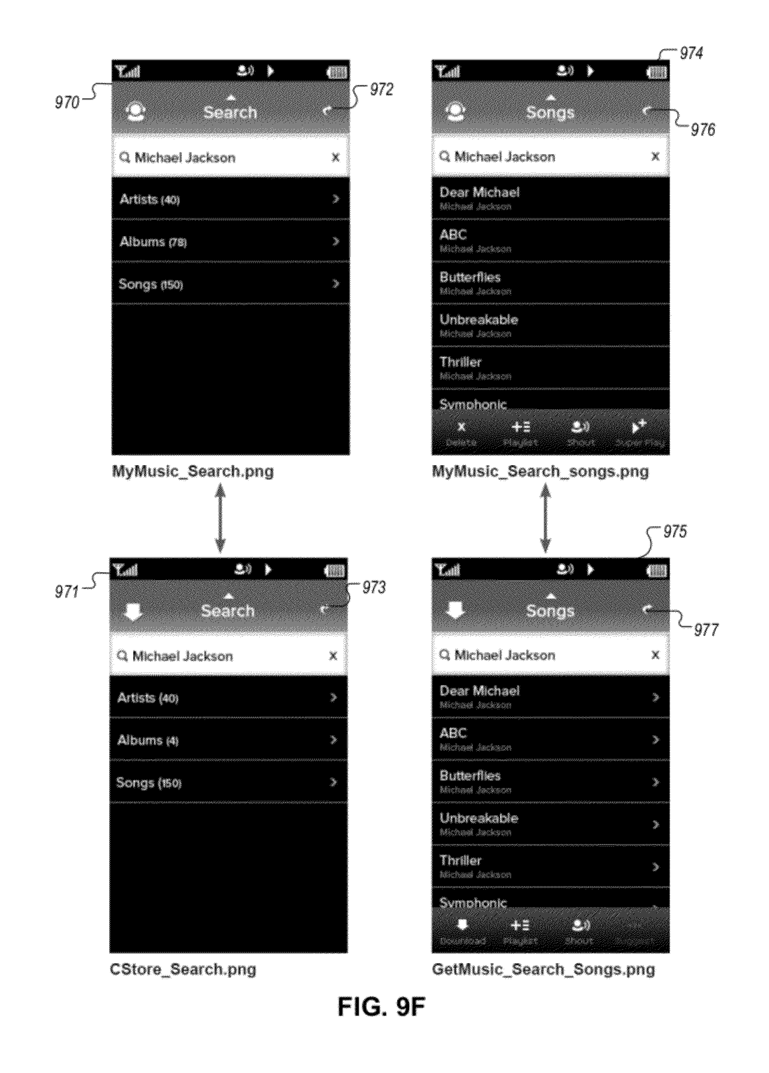

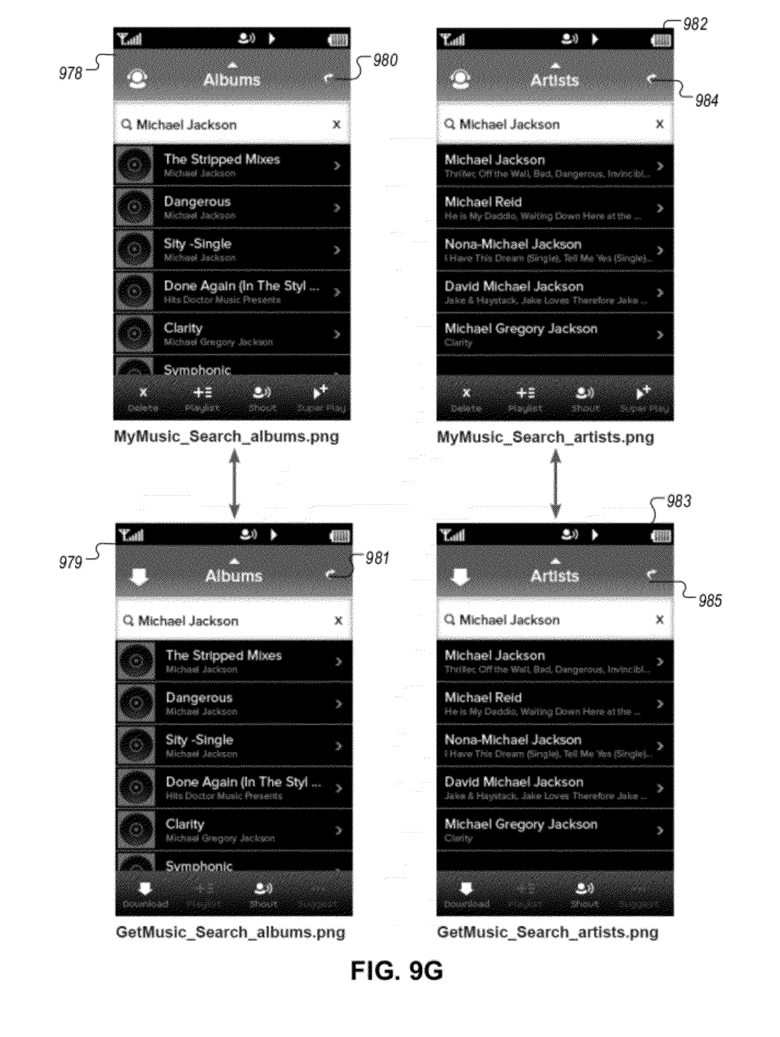

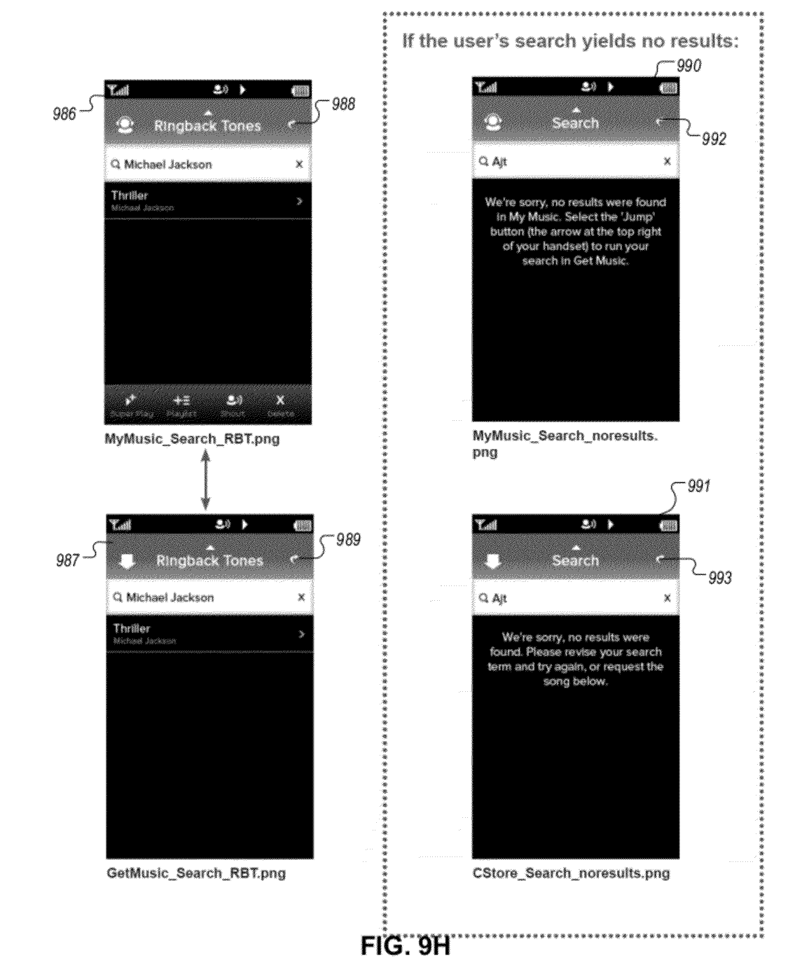

The described techniques for direct navigation can be implemented across different hierarchical areas to allow the user to ‘Jump’ between things, areas, content items, etc. that are thematically or contextually linked with each other. I addition to the examples described above, various other Jumps can be performed using the described technology. FIGS. 9A through 9H show screen shots of user interfaces illustrating various exemplary navigational jumps between thematically or contextually linked areas, content items, etc. As describe above and illustrated in FIGS. 9A through 9H, navigational jumps can be performed between areas that are manual linked by a subscriber or dynamically linked by the described system. Areas can be dynamically linked based on past behaviors, preferences, etc. of the subscriber or relational themes, such as categories, recommend tracks, new releases, top albums and/or songs, featured songs and/or albums, etc. The navigational jumps can allow the user to quickly and easily between thematically and/or contextually linked areas without needing to work his/her way back through the different layers of the user interface hierarchy.

For example, FIG. 9A shows exemplary media interfaces associated with a media application that can be presented by a mobile communications device. A home media interface 900 can be presented, which can provide access to functional areas within the media application as well as access to one or more utilities. The home media interface 900 can be the top-level interface for the media application, and can be implemented substantially similar to the home media interface 400 (see FIG. 4). Among others, home media interface 900 can include selectable icons corresponding to functional areas, including MyMusic icon 902, and GetMusic icon 904. An icon can be selected (or actuated) through any known technique, including through touch and cursor designation. The icons presented are representative and other implementations can include fewer, more, and/or different icons.

User actuation of the MyMusic icon 902 opens the MyMusic interface 906, and user actuation of the GetMusic icon 904 opens the GetMusic 908 interface 908. Because the MyMusic functional area represented by the MyMusic interface 906 and the GetMusic functional area represented by the GetMusic interface 908 are contextually related (e.g., media content items can be added to the MyMusic functional area by downloading from the GetMusic functional area), a user command element (e.g., a button) for performing a navigational jump operation 910 can be actuated on the MyMusic interface 906 to ‘jump’ to the GetMusic functional area. Similarly, the GetMusic interface 908 can include a navigational jump button 912 to ‘jump’ to the MyMusic functional area. Accordingly, a user can actuate the navigational buttons 910 and 912 to jump back and forth between MyMusic interface 906 and GetMusic interface 908. Such navigational jump operations allows the user to navigate between related areas in the media content system using a single button actuation. In the example shown in FIG. 9A, the navigational jumps allows the user to navigate between MyMusic functional area and GetMusic functional area without needing to navigate back to the home media interface 900.

FIGS. 9B, 9C, 9D, 9E, 9F, 9G, and 9H show additional exemplary navigational jump concepts in various context and applications between. The examples shown in FIGS. 9B, 9C, 9D, 9E, 9F, 9G, and 9H show navigational jumps between different hierarchical areas of MyMusic and GetMusic functional areas. However, other functional areas can be similarly linked contextually and/or thematically to allow the user to perform navigational jumps as shown and described with respect to FIGS. 9B, 9C, 9D, 9E, 9F, 9G, and 9H.

In FIG. 9B, a songs interface 914 within the MyMusic interface 906 displays a song list. The user can make a navigational jump directly to a contextually related Top Songs interface 916 by actuating a navigational jump button 918. The user can then jump back to the songs interface 914 by actuating a navigational jump button 920 on the Top Songs interface 916. Other navigational jumps can be performed from the songs interface 914 to lead the user to the top track, root list of songs, most representative or most popular songs, etc.

Also shown in FIG. 9B are exemplary navigational jumps between an albums interface 922 and a contextually related functional area, such as a Top Albums interface 924. The user can actuate a navigational jump button 926 on the albums interface 922 within the MyMusic interface 906 to jump to the top albums interface 928, where a list of most popular albums are displayed for user selection. The user can quickly jump back to the albums interface 922 by actuating a navigational jump button 928 from the top albums interface 924.

FIG. 9C shows exemplary navigational jumps between genres and individual albums that are contextually or thematically linked to each other. For example, from a genres interface 903 within the MyMusic interface 906, the user can quickly jump to a genres related functional area, such as a browse genres interface 932 to browse within different genres. This navigational jump is merely a single click away through actuation of a navigational jump button Once done browsing, the user can jump back to the genres interface 930 by a single actuation of a navigational jump button 936 on the browse genres interface 932.

Also shown in FIG. 9C is an exemplary navigational jump between two related albums. For example, an individual album interface for the album Nevermind 938 can a navigational jump button 942 to allow the user to quickly jump to a related album interface 940, such as Dangerous. These two albums could be linked based on genre, user preference and/or use history, and other thematic and/or conceptual commonalities. The user can jump back to the Nevermind album interface 938 by actuating a navigational button 944 on the Dangerous album interface 940.

Similar to the navigational jumps between related individual album interfaces, a user can perform navigational jumps between thematically or contextually related artists as shown in FIG. 9D. For example, a user can jump from an artist interface 946 for the artist, Nirvana to a contextually and/or thematically related artist interface 948 (e.g., Michael Jackson) to access song from the two related artists. The user can actuate a navigational jump button 950 from the Nirvana interface 946 to jump to the Michael Jackson interface 948. The user can just as easily jump back to the Nirvana interface 946 by actuating a navigational interface 952 on the Michael Jackson interface 948.

Also, jumps can be performed between related hierarchical areas. For example, FIG. 9D also shows making navigational jumps from an individual genre interface 954 (e.g., Alternative genre). While the user is on the alternative genre interface 954 within MyMusic interface 906, the user can actuate a navigational jump button 958 to instantly jump to a related hierarchy, such as a content hierarchy within an online media catalog. FIG. 9D shows a navigational jump from the alternative genre interface 954, by actuating a navigational jump button 958, to an alternative media content catalog interface 956 associated with a content store (e.g., GetMusic functional area) for obtaining (e.g., downloading) featured media content items, new releases, top downloads, etc. within the same alterative genre. User can browse the alternative genre catalog to download and add media content items to his/her MyMusic functional area. The user can jump back to the alternative genre interface after browsing and/or downloading media items by actuating a navigational jump button 960 on the alternative media content catalog interface 956 associated with a content store.

The described navigational jumps can be performed with respect to functional areas in addition to specific media contents, as described above. Also, navigational jumps can be performed with respect to functional areas associated with media content items other than songs. For example. FIG. 9E shows a ringback tones interface 962 within the MyMusic interface 906 that lists the ringback tones currently stored locally in the MyMusic library. The user can perform a navigational jump to a related functional area interface 964, such as a top ringback tones interface within a content item store for purchasing and downloading ringback tones not already owned and stored in the MyMusic library. The user can actuate a navigational jump button 966 on the ringback tones interface 962 within the MyMusic interface 906 to jump to the top ringback tones interface 964 associated with the content item store. After browsing and/or downloading available ringback tones, the user can jump back to the ringback tones interface 964 within the MyMusic interface 906.

FIG. 9F shows on the left hand side, exemplary navigational jumps between search levels of MyMusic and GetMusic functional areas. A user on a search interface 970 within MyMusic interface 906 can search for media content items in the MyMusic library by artist name, album titles, song titles, etc. To obtain additional media content items from the GetMusic functional area, the user can actuate a navigational jump button 972 on the search interface 970 to jump to a related search interface 971 within the GetMusic (e.g., a content items store) interface 908. Once in the search interface 971 within the GetMusic (e.g., a content items store) interface 908, the user can search for and download media content items. The user can jump back to the MyMusic search interface 970 by actuating a navigational jump button 973.

FIG. 9F also shows on the right side, exemplary navigational jumps between search songs levels of MyMusic and GetMusic functional areas. A user on a search songs interface 974 within MyMusic interface 906 can search for media content items, e.g., songs already stored within the MyMusic library for a specific artist, such as Michael Jackson. To obtain additional songs by the same artist from the GetMusic functional area, the user can actuate a navigational jump button 976 on the search songs interface 974 to jump to a related search songs interface 975 within the GetMusic (e.g., a content items store) interface 908. Once in the search songs interface 975 within the GetMusic (e.g., a content items store) interface 908, the user can search for and download songs by Michael Jackson not already in the MyMusic library. The user can jump back to the MyMusic search songs interface 974 by actuating a navigational jump button 977.

FIG. 9G shows exemplary navigational jumps within search albums and search artists levels. On the left hand side of FIG. 9G, a user on a search albums interface 978 within MyMusic functional area can search for albums already in the user's MyMusic library. For example, the user can search for albums by artists with first or last name that match ‘Michael Jackson.’ When a desired album is not found, the user can perform a navigational jump to a related search albums interface 979 within the GetMusic functional area by actuating a navigational jump button 980. The user can jump back to the search albums interface 978 in the MyMusic functional area by actuating a navigational button 981 on the search albums interface 979.

On the right hand side of FIG. 9G, a user on a search artists interface 982 within MyMusic functional area can search for artists already in the user's MyMusic library. For example, the user can search for artists with first or last name that match ‘Michael Jackson.’ When a desired artist and/or associated content items are not found, the user can perform a navigational jump to a related search artists interface 983 within the GetMusic functional area by actuating a navigational jump button 984. The user can jump back to the search artists interface 982 within the MyMusic functional area by actuating a navigational button 985 on the search artists interface 983.

FIG. 9H shows additional exemplary navigational jumps within various search levels. On the left hand side of FIG. 9H, a user on a search ringback tones interface 986 within MyMusic functional area can search for ringback tones already in the user's MyMusic library. For example, the user can search for ringback tones by artists with first or last name that match ‘Michael Jackson.’ When a desired album is not found, the user can perform a navigational jump to a related search ringback tones interface 987 within the GetMusic functional area by actuating a navigational jump button 988. The user can jump back to the search ringback tones interface 986 in the MyMusic functional area by actuating a navigational button 989 on the search ringback tones interface 987 within the GetMusic area.

On the right hand side of FIG. 9H, a user on a search interface 990 within MyMusic functional area can search for a keyword that returns no results in the user's MyMusic library. For example, the user can search for the keyword ‘Ajt’ that results in no matching items. This could be due to the fact that the keyword ‘Ajt’ was a misspelling or simply the MyMusic library did not include any media content items that match the keyword. When the user perform a navigational jump to a related search interface 991 within the GetMusic functional area by actuating a navigational jump button 992, the results of the same keyword search is shown in the search interface 991 within the GetMusic functional area. The user can jump back to the search interface 990 within the MyMusic functional area by actuating a navigational button 993 on the search interface 991 within the GetMusic functional area.

The non-limiting examples and embodiments described with respect to FIGS. 9A, 9B, 9C, 9D, 9E, 9F, 9G and 9H have been described for illustrative purposes. Other navigational jump operations can be performed between contextually or thematically related functional areas, interfaces, hierarchies, and media content items.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising;
displaying to a user, information relating to media content available on a mobile communications device;
navigating, in response to a first user command, to a listing of related content available for download to the mobile communications device;
distinguishing content displayed in the listing of related content that is already stored locally on the mobile communications device from content that is available for download to the mobile communications device; and

2. The method of claim 1 further comprising navigating, in response to a second user command, back to the information relating to media content available on the mobile communications device.

3. The method of claim 1, wherein the media content available on the mobile communications device is a playlist of songs stored locally on the mobile communications device.

4. The method of claim 1, wherein the media content available on the mobile communications device is a remote playlist.

5. The method of claim 4, wherein the remote playlist is a friend's playlist.

6. The method of claim 1, wherein the listing of related content comprises a media compilation or audio-visual work that includes a song included in the media content available on the mobile communications device.

7. The method of claim 1, wherein the listing of related content is albums by the artist of a song included in the media content available on the mobile communications device.

8. The method of claim 2 further comprising storing a state of the mobile communications device at the time of receiving the first command, such that, upon receiving the second command, the mobile communications device can navigate back to the information relating to media content available on the mobile communications device.

9. A mobile device comprising:
a processor; and
a memory coupled with the processor through an interconnect, the memory storing instructions which when executed by the processor cause the mobile device to perform a plurality of operations, including:
displaying to a user a media listing of content available to be played on the mobile device;
navigating, in response to a user command, directly to a collection of downloadable media content related to the media listing of content available to be played on the mobile device; and
distinguishing content displayed in the collection of downloadable media content that is already stored locally on the mobile device from content that is available for download to the mobile device.

10. The mobile device of claim 9 wherein the instructions further cause the processor to perform navigating, in response to a second user command, back to the media listing of content available to be played on the mobile device.

11. The method of claim 9, wherein the media listing of content available to be played on the mobile device is a playlist of songs stored locally on the mobile device.

12. The method of claim 9, wherein the media listing of content available to be played on the mobile device is a remote playlist.

13. The method of claim 9, wherein the listing of related content comprises a media compilation or audio-visual work that includes a song included in the media listing of content available to be played on the mobile device.

14. The method of claim 9, wherein the listing of related content is albums by the artist of a song included in the media listing of content available to be played on the mobile device.

15. The method of claim 10 further comprising storing a state of the mobile device at the time of receiving the first command, such that, upon receiving the second command, the mobile device can navigate back to the information relating to media content available on the mobile device.

16. A method comprising:
displaying to a user on a mobile communications device a media listing;
receiving from the user a command to browse a remote media archive for content related to an item in the media listing;
navigating, in response to the user command, directly to a collection of downloadable media content in the remote media archive that is related to the item in the media listing;
displaying items in the remote media archive such that content displayed in the collection of downloadable media content that is already stored locally on the mobile device is distinguished from content that is available for download to the mobile device;
allowing a user to browse the remote media archive; and
navigating, in response to a second user command, back to the media listing on the mobile communications device.

17. The method of claim 16 further comprising storing a state of the mobile device at the time of receiving the first command, such that, upon receiving the second command, the mobile device can navigate back to the information relating to media content available on the mobile device.

18. The method of claim 17, wherein the media listing displayed on the mobile communications device is a playlist of songs stored locally on the mobile communications device.

19. The method of claim 17, wherein the media listing displayed on the mobile communications device is a remote playlist.

20. The method of claim 19, wherein the remote playlist is a friend's playlist.
